(19) United States
(12) Patent Application Publication
(10) Pub. No.: US 2002/0004408 A1
(43) Pub. Date: Jan. 10, 2002

(54) Portable mobile unit

(76) Inventors: Kiyoshi Masuda, Hitachinaka (JP); Atsushi Uehara, Mito (JP); Junichi Yoshida, Hitachinaka (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/798,274

(22) Filed: Mar. 2, 2001

(30) Foreign Application Priority Data
Jul. 7, 2000 (JP) 2000-211979

(51) Int. Cl. H04M 1/00

(52) U.S. Cl. 455/550; 455/566

(57) ABSTRACT

A portable mobile unit is provided which is easy to search a desired function by using a plurality of routes. The portable mobile unit has: a function information managing unit for classifying function information of the portable mobile unit into groups and hierarchically managing the function information; a storage unit for storing various data; an input unit for inputting information to the portable mobile unit; and a display for displaying various function information items, wherein the portable mobile unit is provided with a function of displaying a result obtained by the function information managing unit in response to a search input, hierarchically searching a function, setting and displaying various information, the function information is classified into at least two groups, and the function information can be hierarchically searched from a plurality of groups.

### BACKGROUND OF THE INVENTION

1. Field of the Invention

The present invention relates to a portable mobile unit utilizing a function of hierarchically searching various functions, and more particularly to a portable mobile unit capable of searching one arbitrary function via a plurality of routes and suitable for improving a handy method of searching a function.

2. Description of the Related Art

Cellular mobile phones with multiple functions are prevailing. The functions include a function search, various setting, data display, mail transfer and the like.

A function of searching a desired function from multiple functions is provided. Namely, functions are classified into groups, each group is divided into upper and lower levels, and each function is searched by using a hierarchically assigned number. However, in this case, since each function belongs only to one group, a hierarchically assigned number is required to be memorized in order to search a desired function. Classification of functions into groups is performed during the manufacture of cellular phones, and some functions are classified into groups which is different from the intuition of users.

An example of a conventional function search will be described with reference to FIGS. 4A and 4B. FIG. 4A shows the hierarchical structure of function items grouped for a function search. FIG. 4B is an example of display images used during a function search.

In the example shown in FIG. 4A, the hierarchical level has two levels, an upper level for large items 221 and a middle level for middle items 222. Nine groups are used including an F0 guide function group 400, an F1 service function group 401, an F2 tone function group 402, an F4 setting function group 404, an F5 restriction function group 405, F6 to F8 function groups (not shown) and an F9 service function group 409. The middle item such as an F11 auto lock indicates a function group. When a desired function is to be searched, relevant function items are traced from the upper level to the lower level. During this search, screen images on a display (not shown) of the cellular phone are sequentially changed from screen images 421 to 425 as shown in FIG. 4B to help a user search a desired function and perform desired setting or display a desired image.

A process of searching an F41 talk time reset function 411 and resetting a talk time will be described with reference to FIG. 4B. First, when an F key (not shown) for starting an F function search is depressed, a letter F is displayed as a screen image 421. Next, since the number of the upper first digit of the number of a desired function large item 221 is “4”, a numerical No. 4 key (not shown) is depressed so that a list of large items 221 from F2 to F6 is displayed as a screen image 422. Since the number of the upper second digit of the number of a desired middle item 222 is “1”, a numerical No. 1 key (not shown) is depressed so that a message is displayed as a screen image 423 to enter the talk time reset function mode. With these operations, a desired function can be searched.

Since a message “reset talk time?” is displayed as a screen image 423, a cursor is positioned on an OK area and activated to reset the talk time so that a lock NO. enquiry message is displayed as a screen image 424. When numerical No. keys corresponding to the number (password) of the lock No., the talk time is reset and a message is displayed as a screen image 425 and the talk time reset operation is completed.

With this method, however, if a user does not know that the talk time reset function is F41, a user sometimes depresses an erroneous numerical No. key (not shown) on the screen image 421 or 422. In such a case, a different function mode is set.

One example of solving this problem is disclosed in JP-A-2000-81937. In this example, a list of functions at the next lower hierarchical level is displayed so that a user can refer to the list and depress a proper numerical No. key. A handy method of searching a function can therefore be improved.

As described above, in a system of a conventional cellular phone, a user is required to perform a number of manipulations in order to search and set a desired function from multiple purposes. In addition, classification of functions into groups is performed during the manufacture of cellular phones, and one function is assigned only to one group. Therefore, if a function is assigned to some group or function group having a name different from the intuition of users, there arises the problem that it takes a time to search a desired function. In such a case, a user is required to memorize an upper hierarchical level and assigned number of the corresponding group, or to manipulate the cellular phone by reading a manual. This is inconvenient for users.

### SUMMARY OF THE INVENTION

It is an object of the present invention to provide a portable mobile unit easy to search a desired function by using a plurality of routes.

In order to solve the above-described problems, according to one aspect of the present invention, there is provided a portable mobile unit comprising: function information managing unit for classifying function information of the portable mobile unit into groups and hierarchically managing the function information; storage unit for storing various data; input unit for inputting information to the portable mobile unit; and displaying unit for displaying various function information items, wherein the portable mobile unit is provided with a function of displaying a result obtained by the function information managing unit in response to a search input, hierarchically searching a function, setting and displaying various information, the function information is classified into at least two groups, and the function information can be hierarchically searched from a plurality of groups.

Since the function information is classified into at least two groups, the function information can be hierarchically searched from a plurality of groups so that the function search becomes efficient and easy.

According to a preferred embodiment, a function is provided for adding/deleting an arbitrary function item to/from an arbitrary group. Accordingly, if a function is added to a group which the user intuition matches, it is possible to search a function starting from a group which the user intuition matches, and a more handy method of searching a function can be realized.

According to another preferred embodiment, a function is provided for forming a group specific to a user and adding an arbitrary function to the group. Accordingly, a function search following just the user intuition is possible, and a more handy method of searching a function can be realized. A group of only those functions which a user prefers or frequently uses may be formed.

According to still another preferred embodiment, a function is provided for changing the hierarchical levels of functions. Accordingly, functions can be classified into groups matching the user intuition, and a more handy method of searching a function can be realized.

By providing a portable mobile unit with such means described above, a desired function can be searched even with user intuition even if the upper hierarchical level and assigned number of a group are not memorized.

According to the invention, a portable mobile unit can be provided which can easily search a desired function by using a plurality of routes.

### BRIEF DESCRIPTION OF THE DRAWINGS

FIGS. 1A is a perspective view of a portable mobile unit used in first to fourth embodiments, and FIG. 1B is a block diagram showing the circuit structure of the portable mobile unit shown in FIG. 1A.

FIG. 2 is a diagram showing the hierarchical structure of function items grouped for function search of the portable mobile unit according to the first embodiment of the invention.

FIG. 3 is a diagram showing the hierarchical structure of function items grouped for function search of the portable mobile unit according to the second, third and fourth embodiments of the invention.

FIG. 4A and 4B illustrate a conventional function search method for a portable mobile unit, FIG. 4A is a diagram showing the hierarchical structure of function items grouped for function search, and FIG. 4B is a diagram showing screen images used during the function search.

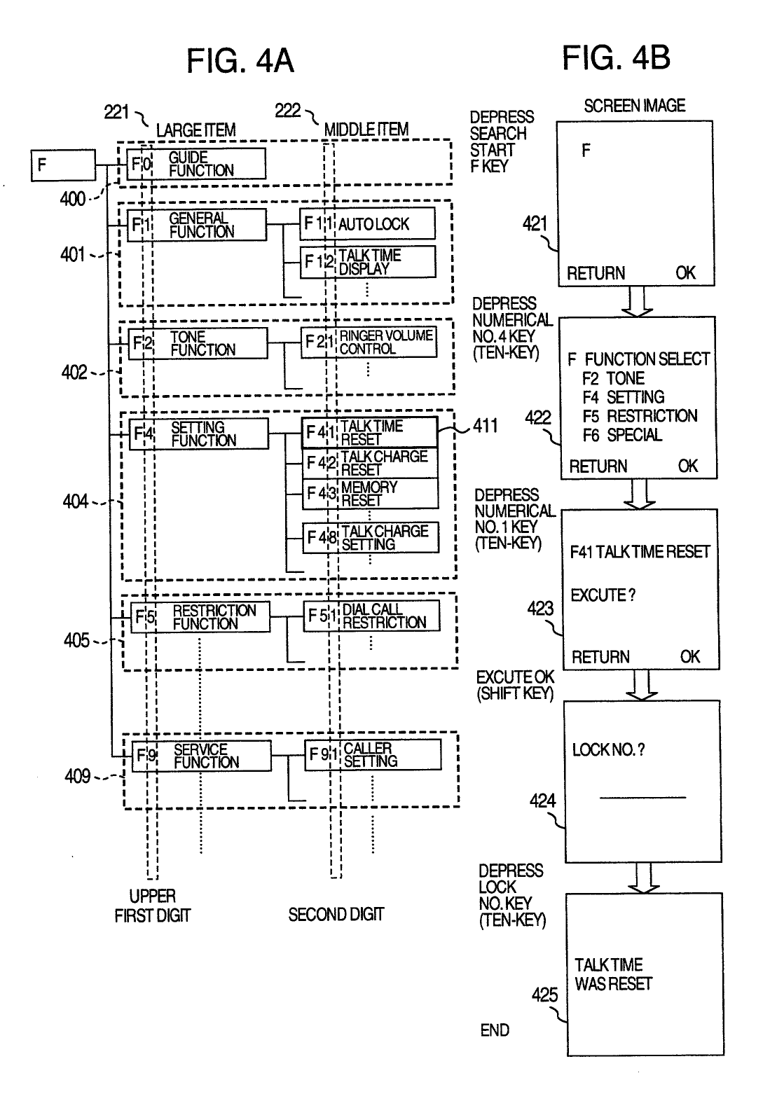

FIG. 5 is a diagram showing the hierarchical structure of function items of the portable mobile unit according to the first embodiment of the invention.

FIG. 6 is a diagram showing examples of a screen image during a function search by the portable mobile unit according to the first embodiment of the invention.

FIG. 7 is a diagram showing the hierarchical structure of function items of the portable mobile unit according to the second, third and fourth embodiments of the invention.

FIG. 8 is a diagram showing examples of a screen image during a function search by the portable mobile unit according to the second, third and fourth embodiments of the invention.

### DETAILED DESCRIPTION OF THE EMBODIMENTS

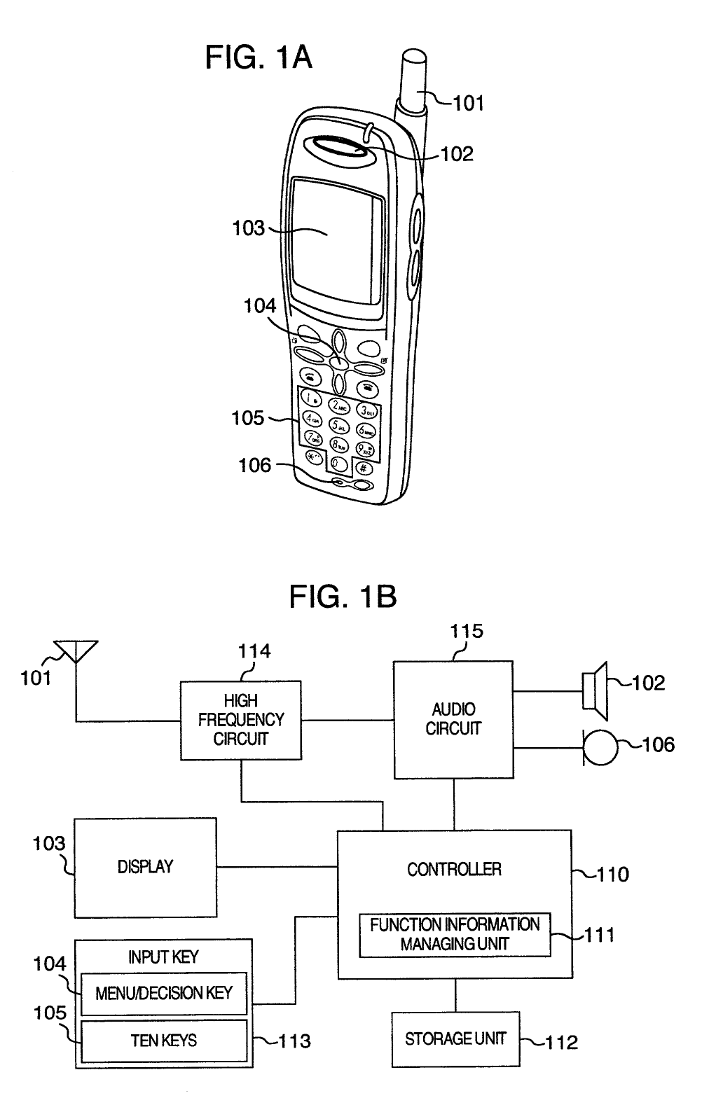

A portable mobile unit according to the embodiments of the invention will be described with reference to FIGS. 1A and 1B, FIGS. 2 and 3, and FIGS. 5 to 8.

The first embodiment of the invention will be described with reference to FIGS. 1A and 1B and FIGS. 2, 5 and 6. In this embodiment, the portable mobile unit is applied to a portable cellular phone. FIG. 1A is a perspective view of the portable cellular phone according to the first embodiment. Reference numeral 101 represents a transmission/reception antenna, reference numeral 102 represents a receiver, reference numeral 103 represents a display for displaying various information, reference numeral 104 represents menu/decision keys to be used for function search, reference numeral 105 represents numerical keys (ten keys) for designating phone numbers and numerical values during function search, and reference numeral 106 represents a transmitter.

The circuit structure of the portable cellular phone of this embodiment is shown in FIG. 1B. Reference numeral 114 represents a high frequency circuit having the function of a transceiver, and reference numeral 115 represents an audio circuit. Reference numeral 113 represents input keys including the menu/decision keys 104 and numerical keys (ten-keys) 105. Reference numeral 110 represents a controller for controlling the entirety of the portable cellular phone, and reference numeral 111 represents a function information managing unit provided in the controller 111. Reference numeral 112 represents a storage unit for storing various data. More specifically, the controller 110 is made of a micro computer (hereinafter described as mi-con), and the function information managing unit 111 is made of a mi-con and has a function of classifying various functions of the portable cellular phone into groups and hierarchically managing them under a control of programs.

The function information managing unit 111 instructs the display 103 to display a result of search inputs from the input keys 113, under the control of the controller 110. A user hierarchically searches a desired function, sets various information or displays information by using the input keys 113 and following the information displayed as screen images on the display 103. The storage unit 112 stores management information of the function information managing unit, and also stores management information on addition, deletion, exchange or the like of optional function items, optional specific groups or the like.

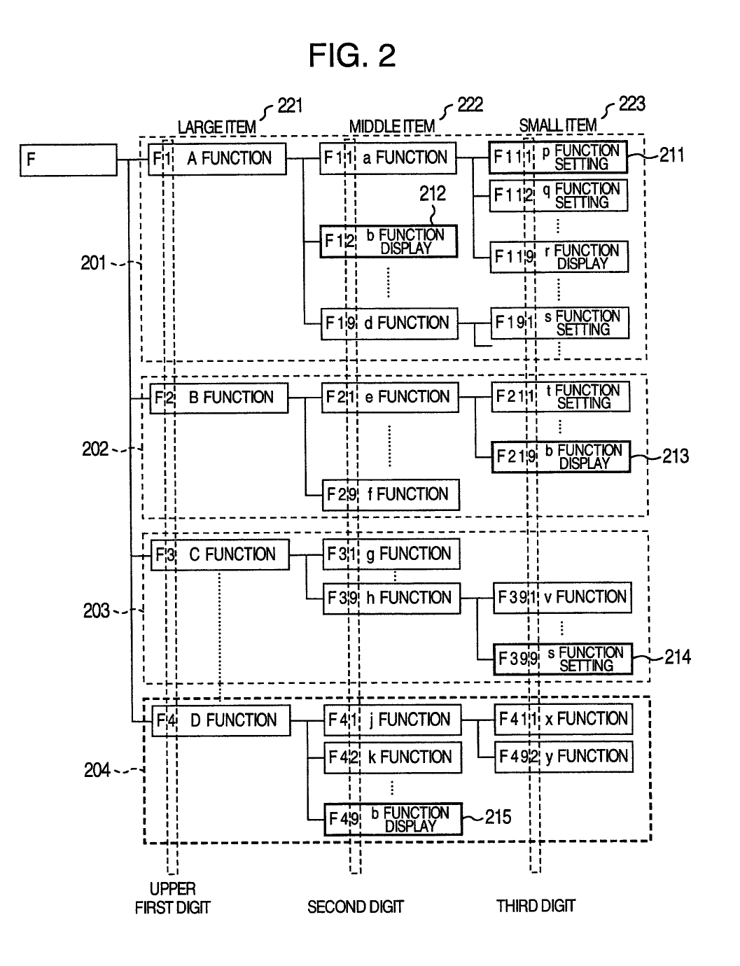

FIG. 2 shows the hierarchical structure of function items grouped for function search, the hierarchical structure being managed by the function information managing unit 111.

The hierarchical level has three levels, an upper level for large items 221, a middle level for middle items 222, and a lower level for small items Four groups are used including an F1: an A function group 201, F2: a B function group 202, F3: a C function group 203, and F4: a D function group 204. The number of groups is not limited to only four. It is sufficient if the number of groups is at least two or more. A desired function is searched from the upper level, middle level to lower level by following the upper first digit number, second digit number and to third digit number. For the purposes of description, the functions are named a, b, c, . . . , z functions. These functions are necessary for using the portable cellular phone, such as selecting a call reception notifying method, selecting the program name of a ringing melody, and selecting a character input mode.

In the example shown in FIG. 2, the p function is set at F111: p function setting 211 and F399: p function setting 214. It is therefore possible to search the p function from either F1: A function group 201 or F3: C function group 203, starting from the higher hierarchical level. Similarly, the b function display is set at F12: b function display 212, F219: b function display 213, and F49: b function display. It is therefore possible to search the b function display from any one of the three function groups.

In this example, although the items of only the A, B, C and D functions are assigned as the large items, it is sufficient if the number of items is set to at least one or more. It is also sufficient if the numbers of middle and small items are set to at least 0 or more for each of the large and middle items, respectively. Further, in this example, although the number of hierarchical levels is three including the upper, middle and lower levels, it is sufficient if the number of hierarchical levels is set to any one of one level to a plurality of levels.

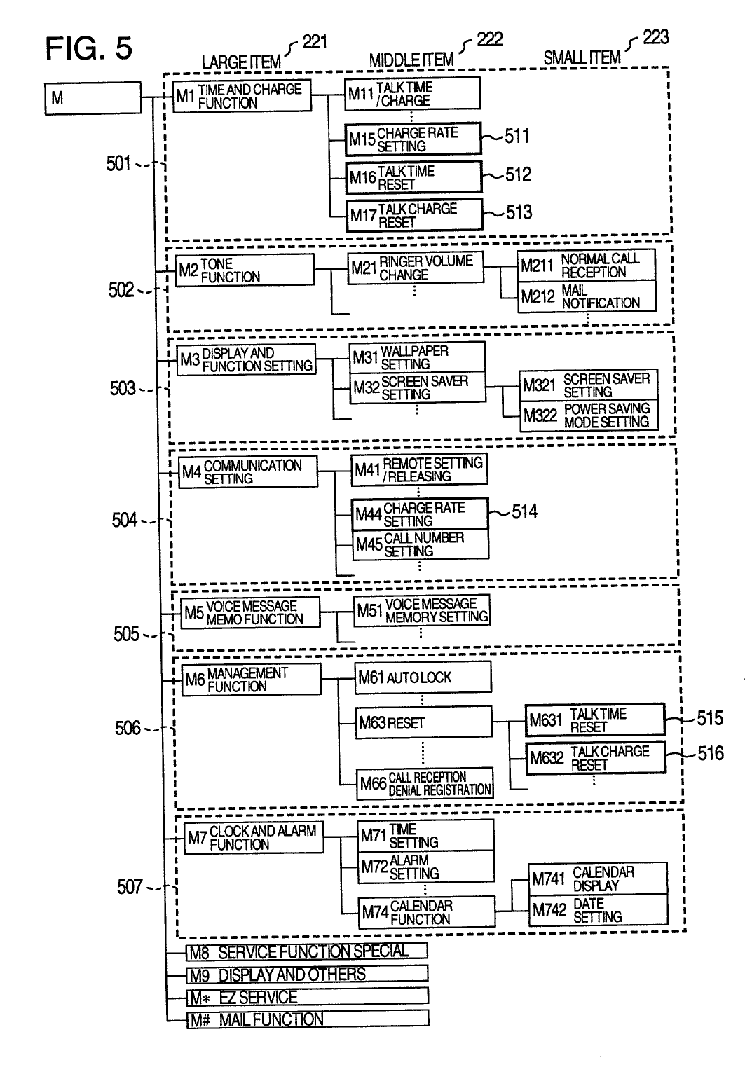

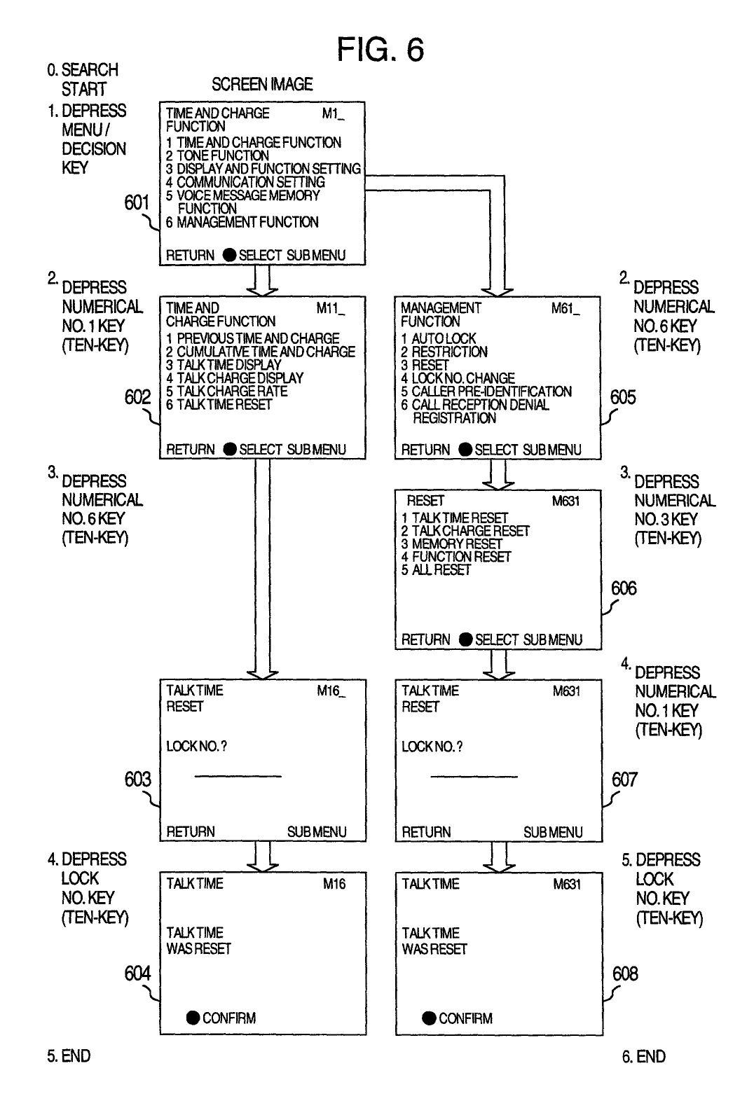

Next, the embodiment will be described more specifically with reference to FIGS. 5 and 6. FIG. 5 is a diagram showing the hierarchical structure of function items managed by the function information managing unit 111 of the portable cellular phone of this embodiment. FIG. 6 shows examples of a screen image during function search.

Referring to FIG. 5, the hierarchical level has three levels, an upper level for large items 221, a middle level for middle items 222, and a lower level for small items 223. Functions for the large item are classified into: a M1 time and charge function group an M2 tone function group 502: an M3 display and function setting group 503: an M4 communication setting group 504: an M5 voice message memo function group 505; an M6 management function group 506: an M7 clock and alarm function group 507; and an M8 service function special/an M9 display and others/M* EZ service/M# mail function. The function groups for the middle and small items are provided at the lower levels of each function group for the large item. In FIG. 5, the F functions shown in FIG. 2 are replaced by menu functions (M functions).

For example, charge rate setting is related to the M1 time and charge function group and set to M15 charge rate setting 511. It is also related to the M4 communication setting group and set to M44 charge rate setting 514. Since the charge rate setting is set to two related groups, even if a user intuitively selects either one of them, it is possible to search and set a desired function. Similarly, talk time reset is set to M16 talk time reset 512 of the M1 time and charge function group and M631 talk time reset 515 of the M6 management group. Talk charge reset is set to M17 talk charge reset 513 of the M1 time and charge function group and M632 talk charge reset 516 of the M6 management function group. Since each function is set to related two groups, even if a user does not know the function number of a desired function, a function search is possible starting from an intuitively selected related function group.

A process of searching the talk time reset function from two routes and resetting the talk time will be described with reference to FIG. 6. FIG. 6 shows examples of a screen image during a function search for the M16 talk time reset 512 and M631 talk time reset 515.

When the menu/decision key 104 for starting a menu function search is depressed, a list of menu functions as large items is displayed as a screen image 601. A time and charge function No. 1 and a management function No. 6 are supposed to be related to the talk time reset function. Assuming that a user depresses the numerical No. 1 key 105, a list of time and charge functions as the middle items is displayed as a screen image 602. Since the talk time reset function is displayed at No. 6, the user depresses the numerical No. 6 key 105 so that a lock No. enquiry message is displayed as a screen image 603 and the mode enters a talk time reset function mode. In the manner described above, a desired function can be searched.

In order to reset the talk time, a lock No. (password) is entered by using the numerical No. key 105. A message is displayed as a screen image 604 and the talk time reset operation is completed. Alternatively, assuming that the numerical No. 6 key 105 is depressed on the screen image 601, a list of management functions as the middle items is displayed as a screen image 605. Since it can be supposed that the No. 3 reset is related to the talk time reset, the user depresses the numerical No. 3 key 105 so that a list of reset functions as the small items is displayed as a screen image 606. Since the talk time reset function is displayed at No. 1, the user depresses the numerical No. 1 key 105 so that the lock No. enquiry message is displayed as a screen image 607 and the mode enters the talk time reset function mode. In this manner, the desired function can be searched. The operations to follow are similar to those described above, and so the description thereof is omitted.

In searching a function, the numerical No. key is used. Instead, a cursor may be moved to a desired No. by using a shift key or a cursor key, and then the decision key is depressed to search a desired function.

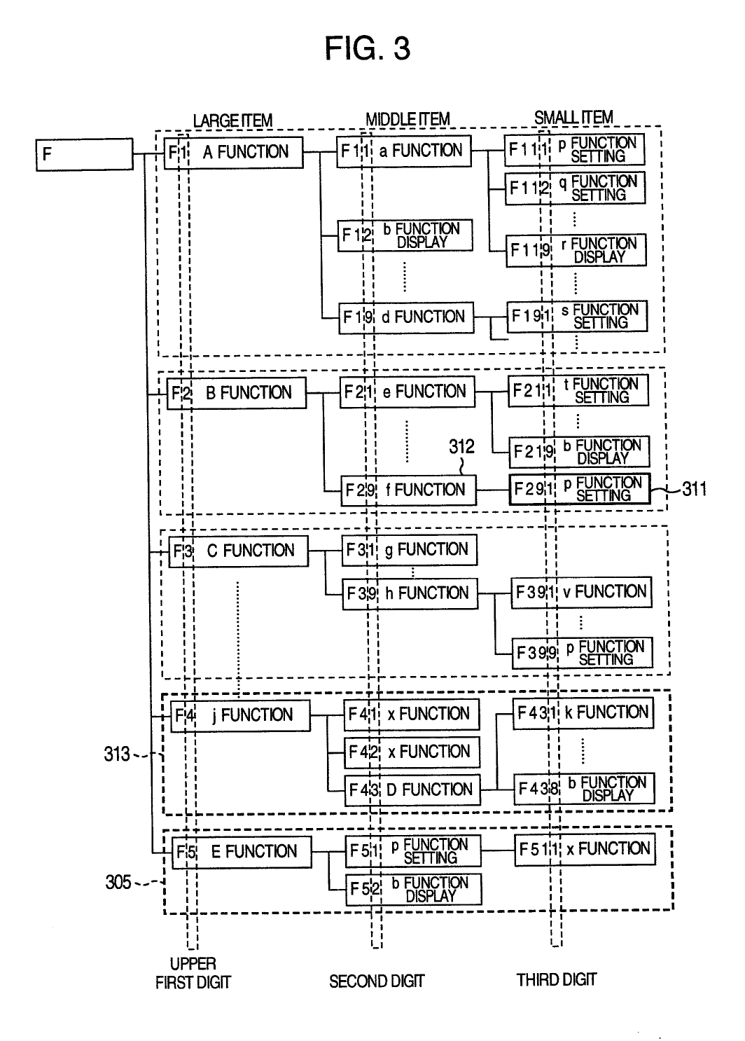

The second embodiment of the invention will be described with reference to FIGS. 1A and 1B and FIGS. 3, 7 and 8. In this embodiment, the function information managing unit can add or delete a function item to and from a desired one of a plurality of function groups. For example, in FIG. 3, since F291: p function setting 311 can also be related to F29: f function 312, this p function setting is added at the lower hierarchical level of F29: f function 312. The function to be added is not limited only to one, but a plurality of functions may also be added.

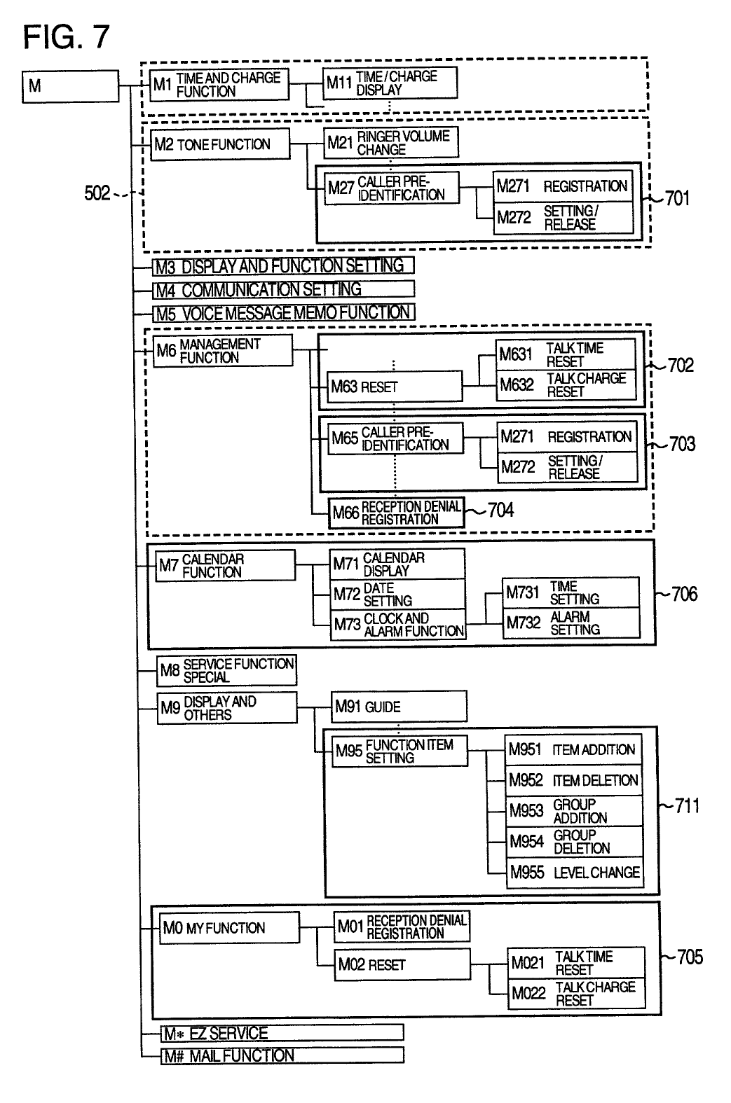

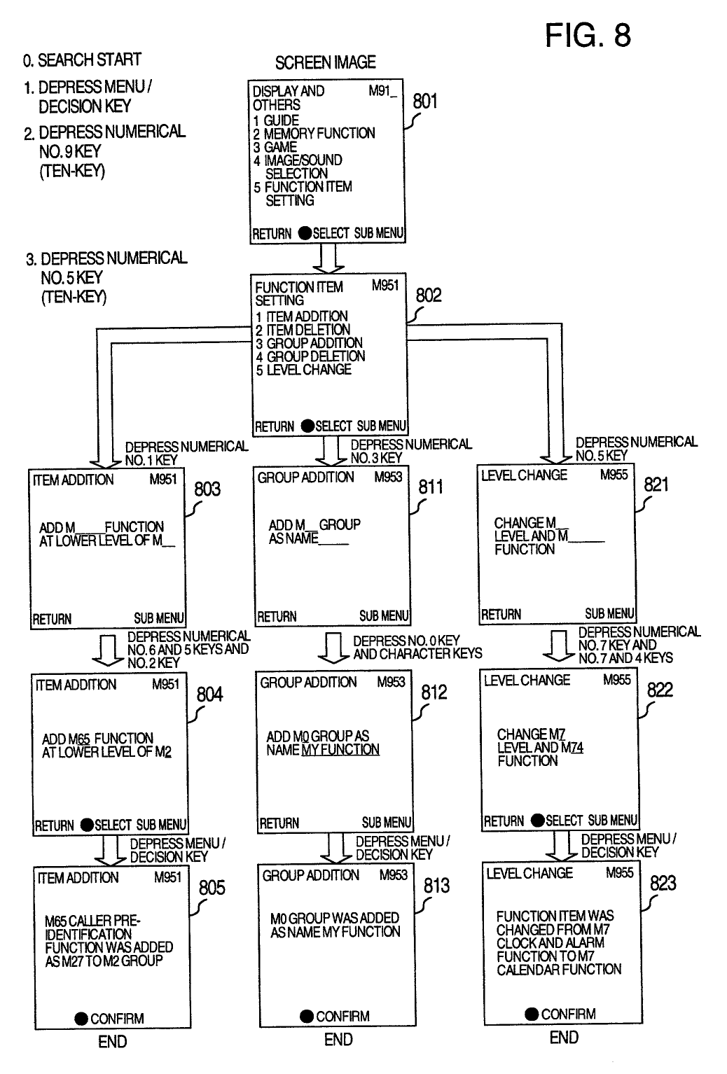

FIG. 7 is a diagram showing the hierarchical structure of function items managed by the function information managing unit 111 of this embodiment. An arbitrary function item is added to an arbitrary one of a plurality of function groups (in this example, M1 to M#), e.g., to the group 502 of “M2 tone function”. As this example, a “caller pre-identification” function item is added to a lower hierarchical level 701 of the “M2 tone function”, and “registration” and “setting/release” functions are added to a lower hierarchical level of the “caller pre-identification” item. Reference numeral 711 represents function item setting functions used for adding and changing each function item. A method of adding a function item by using the function item setting function will be described with reference to FIG. 8. FIG. 8 shows examples of screen images during addition of a function item.

First, an operation of adding the “caller pre-identification” item 701 by using the function of adding/deleting an arbitrary function item to/from an arbitrary group will be described by way of example. As the menu/decision key 104 for starting the menu function search of the portable cellular phone shown in FIG. 1 is depressed and then a numerical No. 9 key 105 for the M9 display and others function which is considered to be related to the function item setting function is depressed, a list of display and others functions as the middle items is displayed as a screen image 801 shown in FIG. 8 on the display 103. Since the function item setting function is displayed at No. 5, the user depresses a numerical No. 5 key 105 so that a list of function item setting functions as small items is displayed as a screen image 802. Since the item addition function is displayed at No. 1, the user depresses a numerical No. 1 key 105 so that an enquiry message for the upper hierarchical level under which the function is added and the function No. is displayed as a screen image 803.

If the function is to be registered to the “M2 tone function” group 502 which the intuition of the user matches, then a numerical No. 2 key 105 and numerical Nos. 6 and 5 keys 105 are sequentially depressed, because the number of the “M2 tone function” is “2” and the number of the “M65 caller pre-identification” function 703 is “65”. A screen image 804 is therefore displayed. As the user depresses the menu/decision key 104, a screen image 805 is displayed which indicates that an unused number M27 was automatically assigned to the M2 group and the “caller pre-identification” function was added as M27. In this manner, a function item addition operation is completed.

By repeating the operation similar to that described above, “M271 registration” and “M272 setting/release” functions are added at the lower hierarchical level of the newly added “M27 caller pre-identification” function.

In the above description, although the number of the added function is automatically selected from unused numbers, the user may manually select a desired number.

In this embodiment, the function of adding/deleting an arbitrary function item to/from an arbitrary group is provided. If a user adds a function item to the group which the intuition of the user matches, it is possible to search a function in accordance with the user intuition and a more handy search method can be realized.

The third embodiment of the invention will be described with reference to FIGS. 1A and 1B and FIGS. 3, 7 and 8. In this embodiment, the function information managing unit can add an arbitrary and independent group and can add a function item arbitrarily selected from various function items to the added, arbitrary and independent group. For example, in FIG. 3, an F5: E function group 305 is newly added as an arbitrary and independent group. The group to be added is not limited to only one, but a plurality of groups may also be added.

FIG. 7 is a diagram showing the hierarchical structure of function items managed by the function information managing unit 111 of this embodiment. An arbitrary and independent “M0 my function” group 705 is added to the plurality of function groups (in this example, M1 to M#), and “M01 reception denial registration” and “M02 reset” functions are added at the lower hierarchical level of the “M0 my function”. “M021 talk time reset” and “M022 talk charge reset” functions are also added at the lower hierarchical level of the “M02 reset”. This function addition is made by using the “function item setting” function 711 similar to the second embodiment. A method of adding a function item will be described with reference to FIG. 8. FIG. 8 shows examples of screen images during addition of a function item. In the display state of the screen image 802, since the group addition function is displayed at No. 3, a user depresses a numerical No. 3 key 105 so that an enquiry message is displayed as a screen image 811 which indicates the number and name of the group to be added. If a group “my function” specific to the user is to be added, an unused number “0” and a name “my function” of the group are entered by sequentially depressing a numerical No. 0 key 105 and a character key (not shown) so that a screen image 812 is displayed. As the menu/decision key 104 is depressed, a screen image 813 is displayed which indicates that the “my function” was added as the “M0” group. A group addition operation is therefore completed. In adding arbitrary functions to the newly added group, the operation similar to that of adding the “caller pre-identification” function 701 of the first embodiment is executed. Specifically, a “reception denial registration” function at the lower hierarchical level of the “M0 my function” group is newly added at the lower hierarchical level of the “M6 management function” as a “M66 reception denial registration” 704, and at the same time, a set of a “reset function” at the lower level of the “M0 my function”, and its lower level “talk time reset” and “talk charge reset” functions is added as an “M63 reset function,” and its lower level “M631 talk time reset” and “M632 talk charge reset”. This added set will be described hereinunder as a “M63 reset function” 702. In adding a function item at a lower level of the added function item, the function “M951 item addition” is used in the above description similar to the first embodiment. However, a function item at the lower level may be automatically assigned or added when the new function item is added.

In this embodiment, a group specific to a user is set and an arbitrary function is added to this group. It is possible to search a function in accordance with the user intuition and a more handy search method can be realized. As a set of functions such as “talk time reset” and “talk charge reset” is added, it is possible to form a group of only those functions which a user prefers or frequently uses.

The fourth embodiment of the invention will be described with reference to FIGS. 1A and 1B and FIGS. 3, 7 and 8. In this embodiment, the function information managing unit can change the level of upper and lower hierarchical levels as desired. For example, in FIG. 3, an “F4: D function” which was the large item in an “F4: j function group” 313 was replaced by an “F41: j function” which was the middle item to thereby change the hierarchical levels thereof. A replacement is not limited to only one set, but a plurality of sets may also be replaced.

As a specific example of this embodiment, a replacement of an upper hierarchical level by a lower hierarchical level in an “M7 calendar function” group 706 shown in FIG. 7 will be described. In this example, the levels are changed because if the calendar function is positioned at the level higher than that of the clock and alarm function, this structure is nearer to the user intuition and a function search becomes easier. In the display state of a screen image 802 shown in FIG. 8, since a hierarchical level change function is displayed at No. 5, a user depresses a numerical No. 5 key 105 of the input unit shown in FIGS. 1A and 1B so that an enquiry message is displayed as a screen image 821 which indicates the number of a function at an upper hierarchical level and the number of a function at a lower hierarchical level to be replaced by the upper level function was changed. In the initial state, the number of an “M7 clock and alarm function” at the upper level is “7”, and the number of an “M74 calendar function” at the lower level is “74”. Therefore, a user sequentially depresses numerical Nos. 7, 7 and 4 keys 105 so that a screen image 822 is displayed. By depressing menu/decision key, a screen image 823 is displayed, which indicates that the “M7 clock and alarm function” item was changed to an “M7 calendar function” item. A “calendar display” and a “date setting” at the lower level of the “calendar function” are automatically assigned numbers corresponding to the lower level of the “M7 calendar function” to form an “M71 calendar display” and “M72 date setting”. A clock and alarm function” is also automatically assigned a number corresponding to the lower level of the “M7 calendar function” to form an “M73 clock and alarm function”. A “time setting” and an “alarm setting” at the lower level of the “clock and alarm function” are also automatically assigned numbers corresponding to the lower level of the “M73 clock and alarm function” to form an “M731 time setting” and “M732 alarm setting”.

In this embodiment, a function of changing the order of hierarchical levels is provided. Therefore, large items can be classified into groups nearer to the user intuition, and a more handy method of searching a function can be realized.

According to the above embodiments, a desired function can be searched by using a plurality of routes. Therefore, even if a user does not memorize the corresponding upper hierarchical level, the user can search a desired function by using the intuition. The inconvenience of memorizing a corresponding upper hierarchical level of the group or manipulating the portable mobile unit while reading a manual can therefore be solved, and a desired function can be searched even with the intuition. Further, since a function can be added/deleted to/from a group which can be identified from the user intuition, a more handy method of searching a function can be realized. It is obvious that any function item or any number of items can be used if such items are provided by the portable mobile unit, and that the screen images and search manipulation are not limited only to the above embodiments.

In the above embodiments, although a portable cellular phone is used, the invention is not limited only thereto, but is applicable to all general portable mobile wireless units or portable mobile units if they can search and set a function item and display information.

What is claimed is:

1. A portable mobile unit comprising:
function information managing means for classifying function information of the portable mobile unit into groups and hierarchically managing the function information;
storage means for storing various information;
input means for inputting information to the portable mobile unit; and
displaying means for displaying various function information items,
wherein the portable mobile unit is provided with a function of displaying a result obtained by said function information managing means in response to a search input, hierarchically searching a function, setting and displaying various information, the function information is classified into at least two groups, and the function information can be hierarchically searched from a plurality of groups.

2. A portable mobile unit according to claim 1, wherein said function information managing means can add or delete the various function information to or from an arbitrary group of the plurality of groups of the function information.

3. A portable mobile unit according to claim 1, wherein said function information managing means can add an arbitrary independent group and in addition can add a function information item arbitrarily selected from the various function information items to the added arbitrary independent group.

4. A portable mobile unit according to claim 1, wherein said function information managing means can arbitrarily change an order of upper and lower hierarchical levels.
